(19) United States
(12) Patent Application Publication
(10) Pub. No.: US 2014/0118543 A1
(43) Pub. Date: May 1, 2014

(54) METHOD AND APPARATUS FOR VIDEO ANALYSIS ALGORITHM SELECTION BASED ON HISTORICAL INCIDENT DATA

(71) Applicant: MOTOROLA SOLUTIONS, INC., Schaumburg, IL (US)

(72) Inventors: GLENN F. KERBS, RIVERSIDE, IL (US); MATTHEW C. KELLER, BARRINGTON, IL (US)

(73) Assignee: MOTOROLA SOLUTIONS, INC., Schaumburg, IL (US)

(21) Appl. No.: 13/665,879

(22) Filed: Oct. 31, 2012

(51) Int. Cl. H04N 7/18

(52) U.S. Cl. 348/143; 348/E07.085

(57) ABSTRACT

A method and apparatus to provide a VAE schedule to a camera is provided herein. During operation, a processor extracts historical incident data and generates an incident heat map of an area based on the historical incident data. A camera viewshed is determined and utilized along with the incident heat map to determine a VAE schedule for use with a camera.

### FIELD OF THE INVENTION

The present invention generally relates to surveillance camera adjustments, and more particularly to a method and apparatus for automatically adjusting a surveillance camera's video analysis engine schedule based on historical incident data.

### BACKGROUND OF THE INVENTION

The use of surveillance video continues to grow across enterprise and public safety markets. However, public safety agencies across the country struggle with using video analytics in their video surveillance systems due to the difficulty in selecting the right type of events to detect. Processing and bandwidth constrained devices often limit the number of different video analytics that can be run on a particular video stream. The use of video analytics to detect a particular event is viewed as very important to changing the value of video surveillance from an after the fact forensic tool for crime solving to a more real-time model where real-time incident detection and prevention are the goals. Agencies need a way to assure that the right analysis algorithms (video analysis engine) are being used on the right cameras at the appropriate times. As more specialized types of analytics are developed, this need will only increase. Therefore, a need exists for a method and apparatus for selecting a best video analysis engine to run on a particular camera at a particular time.

### BRIEF DESCRIPTION OF THE DRAWINGS

The accompanying figures where like reference numerals refer to identical or functionally similar elements throughout the separate views, and which together with the detailed description below are incorporated in and form part of the specification, serve to further illustrate various embodiments and to explain various principles and advantages all in accordance with the present invention.

FIG. 1 is block diagram detailing a video analysis engine scheduler.

FIG. 2 is block diagram detailing a camera controller.

FIG. 3 is a block diagram detailing a camera.

FIG. 4 is a flow chart showing the operation of the video analysis engine scheduler of FIG. 1.

FIG. 5 is a flow chart showing the operation of the camera controller of FIG. 2.

FIG. 6 is a flow chart showing the operation of the camera of FIG. 3.

FIG. 7 is a block diagram of network equipment running a video analytic schedule.

FIG. 8 is a flow chart showing operation of the video analysis engine scheduler of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required.

### DETAILED DESCRIPTION

In order to address the aforementioned need, a method and apparatus for determining a video analysis engine (VAE) schedule for a video stream is provided herein. During operation, a processor analyzes historical incident data and determines the type of incident most-likely to occur within the camera's viewshed. An appropriate VAE schedule is then determined for the video stream based on the type of incident most likely to occur.

Describing the above in further detail, historical incident data is processed to create an incident heat map comprising types and times of incidents that occur most often at a particular camera's location. The historical incident data may be obtained for example from a CAD (Computer Aided Dispatch) or a RMS (Records Management Systems) within the public safety dispatch system or a Customer Service Request system within a municipality. Incidents may comprise any event that is desired to be detected by the camera. For example, types of incidents may comprise any type of crime, traffic accidents, weather phenomenon, etc. The creation of a heat map may be accomplished via a standard software package such as The Omega Group's CrimeView® desktop crime analysis and mapping solution. This incident data heat map is used to identify the types of incidents that occur most often within parts of a city, building, or other area during a given time period. An assumption is made that past incidents at a particular location and time is an indicator of likely future incidents of a similar type at that location at similar times.

The incident heat map may vary depending on time of day, time of year, and environmental factors such as weather conditions and the like. For example, an incident heat map may comprise all robberies that occurred within the overnight hours on a Saturday night for a city. Armed with this knowledge, an assumption can be made when, and under what conditions future types of similar incidents are most likely to occur, for example using predictive crime algorithms which may also be used to generate the heat map, showing expected hot spots. A heat map may also indicate a most-likely type of incident occurring within a particular area during a particular time period. For example, a heat map may indicate that illegal drug sales are most likely to occur at a particular area before noon.

A VAE schedule can then be constructed to cover some time period (i.e., a day), such that for a given time, date, and set of environmental conditions, a particular VAE is used to detect a particular type of incident from the video stream that is most likely to occur. The above process can be repeated after a predetermined period of time, for example, on a daily, weekly, or monthly schedule.

Operating network equipment (e.g., cameras, network equipment, etc.) as described above will automatically adjust their VAE to provide an improved chance of real-time identification of future incidents on a video stream. Consider the following example; Bar A (in camera's viewshed) closes at 2 AM each night and historical incident data indicates a significant increase in the rate of assault and battery incidents in the vicinity between 2 to 3 AM on Fridays and Saturdays. Using this information, an optimal VAE schedule may be determined for the camera. In this example, the camera's VAE schedule may select a particular VAE that better detects assault and battery from 2 to 3 AM on Fridays and Saturdays.

If the historical incident data shows additional correlation beyond date, time, or season to more complex environmental factors such as weather patterns, moon phase, etc., a more dynamic VAE schedule can be constructed accordingly. For example, historical incident data may indicate a higher occurrence of traffic accidents at a particular intersection on rainy nights. As such, if a weather forecast calls for rain during the nighttime hours, the camera's VAE schedule could be automatically updated to use a VAE that better detects traffic accidents at the intersection in question. This update may happen in advance based on a weather forecast, or it may happen automatically upon detection of rainfall.

Prior to describing the system shown for accomplishing the above, the following definitions are provided to set the necessary background for utilization of the present invention.

Incident Data comprises a record of incidents. Typically, at a minimum, the location, type, severity, and date/time attributes of the incident are recorded. Additional environmental factors may also be recorded (e.g., the weather at the time of the incident, etc). Examples of incident data include, for example, crime data, traffic accident data, weather phenomena, and/or individual schedules (e.g., a mayor's schedule).

Incident Heat Map comprises a map generated by analyzing geocoded historical incident data that indicates the relative density of incidents and types of incidents across a geographical area. Areas with a higher density of incidents are typically referred to as ‘hot’ (and often visually displayed with shades of red) and areas with low incident density are referred to as ‘cold’ (and often visually displayed with shades of blue). Prior to rendering the incident heat map, the incident data may be filtered based on any number of attributes. For example, one could build an incident heat map depicting only muggings over the past month occurring in the overnight hours.

Video Analysis Engine (VAE) comprises a software engine that analyzes analog and/or digital video. The engine is able to “watch” video and detect pre-selected events. Each VAE may contain any of several event detectors. Each event detector “watches” the video for a particular type or class of events. Event detectors can be mixed and matched depending upon what is trying to be detected. For example, a loitering event detector may be utilized to detect solicitation, illegal drug sales, or gang activity. On detecting a particular event, the VAE will report the occurrence of the event to a network entity along with other pertinent information about the event. With this in mind, a particular VAE is used depending upon what type of incident is being detected.

Camera Viewshed comprises the spatial area that a given camera can potentially view. The viewshed may take into account the geographical location of the camera, mounting height, and Pan Tilt Zoom (PTZ) capabilities of the camera while also accounting for physical obstructions. These obstructions may be determined by a topographical map. The viewshed may also take into account all the views possible for a camera that has the ability move its geographic location (like a camera on a moveable track or mounted in an unmanned aerial vehicle).

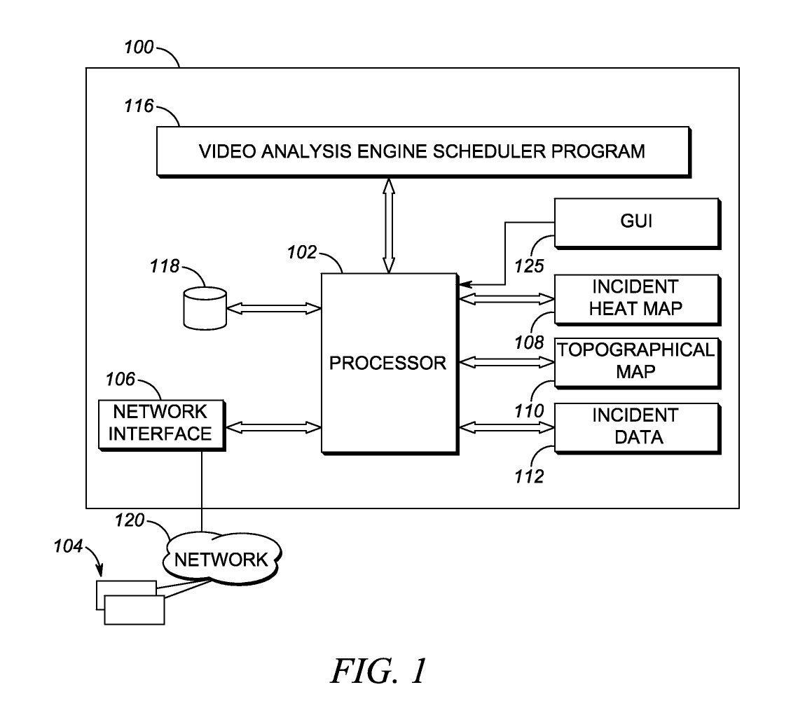

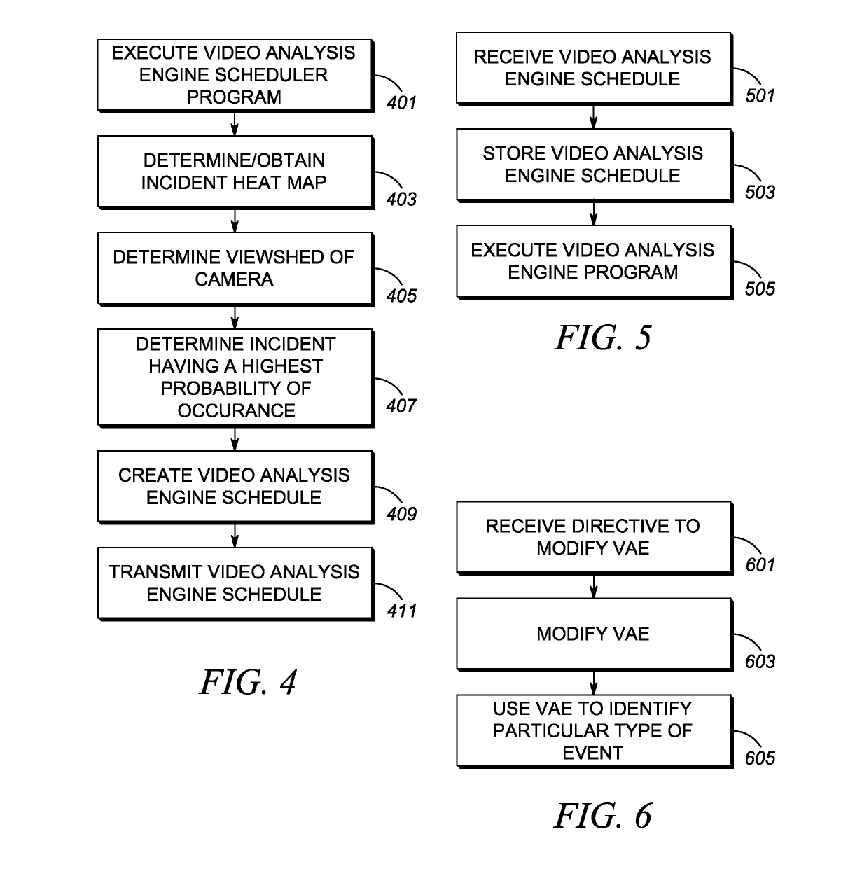

FIG. 1 is a block diagram illustrating a general operational environment detailing VAE scheduler 100 according to one embodiment of the present invention. In general, as used herein, the VAE scheduler 100 being “configured” or “adapted” means that the scheduler 100 is implemented using one or more components (such as memory components, network interfaces, and central processing units) that are operatively coupled, and which, when programmed, form the means for these system elements to implement their desired functionality, for example, as illustrated by reference to the methods shown in FIG. 4.

In the current implementation, VAE scheduler 100 is adapted to compute VAE schedules for multiple cameras and provide the schedules to a camera controller. However it should be understood that various embodiments may exist where the camera controllers or cameras themselves compute their own VAE schedules as described below.

Scheduler 100 comprises a processor 102 that is communicatively coupled with various system components, including a network interface 106, a general storage component 118, a storage component storing an incident heat map 108, optionally a storage component storing a topographical map 110, and a storage component storing incident data 112. The analytic engine scheduling scheduler 100 further comprises a VAE scheduler program 116 which may execute via an operating system (not shown). Only a limited number of system elements are shown for ease of illustration; but additional such elements may be included in the analytic engine scheduling scheduler 100. The functionality of the analytic engine scheduling device may be embodied in various physical system elements, including a standalone device, or as functionality in a Network Video Recorder device (NVR), Digital Video Recorder device (DVR), a Physical Security Information Management (PSIM) device, a camera controller 104, a camera 204, a Wireless LAN Controller device (WLAN), or any other physical entity.

The processor 102 may be partially implemented in hardware and, thereby, programmed with software or firmware logic (e.g., the VAE scheduler program 116) for performing functionality described in FIG. 4; and/or the processor 102 may be completely implemented in hardware, for example, as a state machine or ASIC (application specific integrated circuit). All storage and components can include short-term and/or long-term storage of various information needed for the functioning of the respective elements. The storage 118 may further store software or firmware (e.g., the VAE scheduler program 116) for programming the processor 102 with the logic or code needed to perform its functionality.

In the illustrative embodiment, one or more camera controllers 104 are attached (i.e., connected) to the analytic engine scheduling scheduler 100 through network 120 via network interface 106. Example networks 120 include any combination of wired and wireless networks, such as Ethernet, T1, Fiber, USB, IEEE 802.11, 3GPP LTE, and the like. Network interface 106 connects processor 102 to the network 120. Where necessary, network interface 106 comprises the necessary processing, modulating, and transceiver elements that are operable in accordance with any one or more standard or proprietary wireless interfaces, wherein some of the functionality of the processing, modulating, and transceiver elements may be performed by means of the processor 102 through programmed logic such as software applications or firmware stored on the storage component 118 or through hardware.

VAE scheduler program (instructions) 116 may be stored in the storage component 118, and may execute via an operating system (not shown). When the VAE scheduler program 116 is executed, it is loaded into the memory component (not shown) and executed therein by processor 102. Processor 102 uses the VAE scheduler program 116 to analyze incident data along with other relevant inputs and generate an incident heat map that indicates what types of incidents are most likely to occur over a particular area. Using a particular camera's geographic location or set of possible geographic locations and a topographical map 110, a camera viewshed is calculated. Alternatively, instead of being calculated, the camera viewshed may be obtained via other means (for example, a person may manually determine the camera viewshed via visual inspection of all the possible fields of view of the camera). The processor 102 then compares the incident heat map against the camera's viewshed. A VAE schedule is then constructed for a camera such that multiple VAEs may be used at differing times so that the camera is more capable of identifying the type of incident most-likely to occur. The VAE schedule is then transmitted to camera controller 104 through network 120.

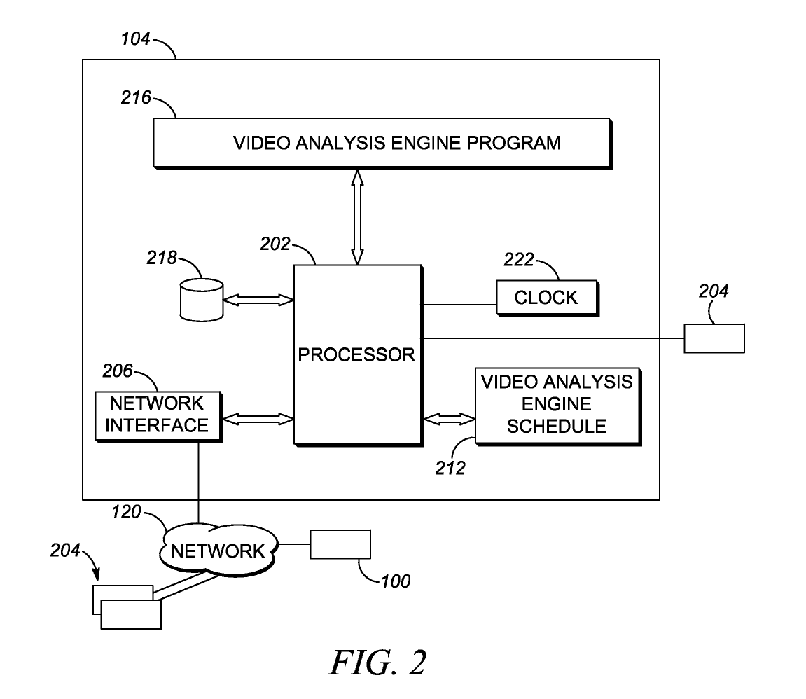

FIG. 2 is a block diagram illustrating a general operational environment detailing camera controller 104 according to one embodiment of the present invention. In general, as used herein, the camera controller 104 being “configured” or “adapted” means that the controller 104 is implemented using one or more components (such as memory components, network interfaces, and central processing units) that are operatively coupled, and which, when programmed, form the means for these system elements to implement their desired functionality, for example, as illustrated by reference to the methods shown in FIG. 5. Camera controller 104 comprises a processor 202 that is communicatively coupled with various system components, including a network interface 206, a general storage component 218, and a storage component storing a VAE schedule 212. The camera controller 104 further comprises a VAE program 216 which may execute via an operating system (not shown). Only a limited number of system elements are shown for ease of illustration; but additional such elements may be included in the camera controller 104.

The functionality of the camera controller device may be embodied in various physical system elements, including a standalone device, or as functionality in a Network Video Recorder device (NVR), a Digital Video Recorder device (DVR), a Physical Security Information Management (PSIM) device, a VAE scheduler 100, a camera 204, a Wireless LAN Controller device (WLAN), or any other physical entity. In other words, although shown as a stand-alone device, scheduler 100 may be included within a camera 204, or camera controller 104.

The processor 202 may be partially implemented in hardware and, thereby, programmed with software or firmware logic or code (e.g., the VAE program 216) for performing functionality described in FIG. 5; and/or the processor 202 may be completely implemented in hardware, for example, as a state machine or ASIC (application specific integrated circuit). All storage and components can include short-term and/or long-term storage of various information needed for the functioning of the respective elements. Storage 218 may further store software or firmware (e.g., the VAE program 216) for programming the processor 202 with the logic or code needed to perform its functionality.

In the illustrative embodiment, one or more cameras 204 are either directly connected to controller 104, or attached (i.e., connected) to the camera controller 104 through network 120 via network interface 206. Network interface 206 connects processor 202 to the network 120. Camera controller 104 is adapted to control the VAE used by any camera 204 that it is in communication with. These include cameras connected to controller 104 through network 120, or cameras 204 directly coupled to controller 104.

VAE schedules are periodically received from scheduler 100 and stored in storage 212. VAE program 216 may be stored in the storage component 218, and may execute via an operating system (not shown). When the VAE program 216 is executed, it is loaded into the memory component (not shown) and executed therein by the processor 202. Once executed, the VAE program will load and execute, for each configured camera 204, a VAE schedule 212 as determined and provided by VAE scheduling scheduler 100. As VAE program 216 is executed, processor 202 will send appropriate commands to cameras 204 to adjust their utilized VAE accordingly.

For example, processor 202, per VAE schedule 212, may instruct a camera 204 to change its VAE so that a first VAE is used for a first period of time, then after the first period of time has passed, the processor 202 may instruct the camera 204 to change its VAE to use a second VAE for a second period of time. The VAE used by any given camera at any given time is preferably adapted to detect the type of incident that is most likely to occur within the camera's viewshed (as determined by the heat map).

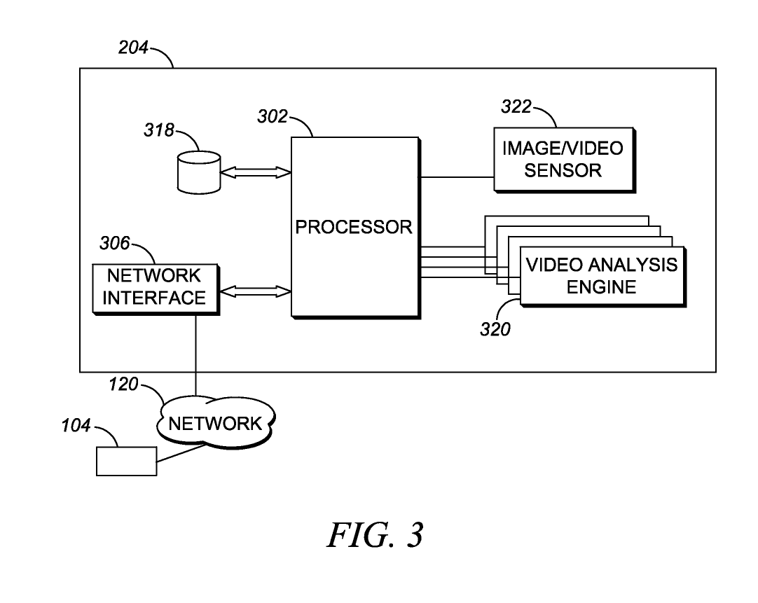

FIG. 3 is a block diagram illustrating a general operational environment detailing camera 204 according to one embodiment of the present invention. In general, as used herein, the camera 204 being “configured” or “adapted” means that the device 204 is implemented using one or more components (such as memory components, network interfaces, and central processing units) that are operatively coupled, and which, when programmed, form the means for these system elements to implement their desired functionality, for example, as illustrated by reference to the methods shown in FIG. 6. Camera 204 comprises a processor 302 that is communicatively coupled with various system components, including a network interface 306, a general storage component 318, a plurality of VAEs 320, and an image or video sensor 322 to capture images or video. Only a limited number of system elements are shown for ease of illustration; but additional such elements may be included in the camera 204. The functionality of the camera device may be embodied in various physical system elements, including a standalone device, or as functionality in a Network Video Recorder device (NVR), a Digital Video Recorder device (DVR), a Physical Security Information Management (PSIM) device, a VAE scheduler 100, a camera controller 104, a Wireless LAN Controller device (WLAN), or any other physical entity.

The processor 302 may be partially implemented in hardware and, thereby, programmed with software or firmware logic or code for performing functionality described in FIG. 6; and/or the processor 302 may be completely implemented in hardware, for example, as a state machine or ASIC (application specific integrated circuit). All storage and components can include short-term and/or long-term storage of various information needed for the functioning of the respective elements. Storage 318 may further store software or firmware for programming the processor 302 with the logic or code needed to perform its functionality.

Sensor 322 (also interchangeably referred to herein as video camera or digital video camera) electronically captures a sequence of video frames (i.e., a sequence of one or more still images), with optional accompanying audio, in a digital format and outputs this as a video stream. Although not shown, the images or video detected by the image/video sensor 322 may be stored in the storage component 318, or in any storage component accessible via network 120.

In the illustrative embodiment, a camera 204 is attached (i.e., connected) to a camera controller 104 through network 120 via network interface 306, although in alternate embodiments, camera 204 may be directly coupled to controller 104. Network interface 306 connects processor 302 to the network 120.

Processor 302 receives directives to modify its VAE from camera controller 104. These directives may comprise a simple instruction to utilize a specific VAE, or may comprise execution of a schedule that is stored in database 318. For example, ten cameras 204 may be deployed at various locations around a neighborhood, and all ten cameras may be attached to one camera controller 104 through network 120. Scheduler 100 sends VAE schedules for the cameras 204 to the camera controller 104 via network 120. The camera controller 104 uses clock 222 and the respective VAE schedules, sending directives to modify the VAE to each camera 204 at the correct time to affect the requested VAE schedule. These VAE schedules may be similar of different, and are uniquely adapted to each camera's viewshed and are based on past incident data within the camera's viewshed, such that the VAE used by any particular camera is based on an incident's probability of occurring. Processor 302 then modifies its VAE according to the schedule. Processor 302 then receives video (a video stream) from sensor 322 and uses the appropriate VAE to detect a particular incident. If detected, processor 302 may notify the appropriate authorities through network 120.

FIG. 4 is a flow chart depicting the operation of the VAE scheduler 100 of FIG. 1. It should be noted that although many steps are shown in FIG. 4, not all steps are necessary. Additionally, the process flow of FIG. 4 describes the generation of a VAE schedule by VAE scheduler 100. As described above, it is not necessary that the VAE schedule be generated by VAE scheduler 100. In alternate embodiments of the present invention, this functionality may be located in the camera controllers, cameras, or other system elements.

The logic flow begins at step 401 with the execution of VAE scheduler program 116. When executed, processor 102 determines or obtains a geographic location or set of possible geographic locations (in the case of a moveable camera) for a particular camera 204 and determines and/or obtains an incident heat map for the geographic location using historical incident data (step 403). This heat map preferably indicates what types of incidents have a highest probability of occurring for a given geographical area over a period of time. It should be noted that not all “types” of incidents may be included when determining those with the highest probability of occurring. Only those incidents determined to be significant may be utilized when determining those that have the highest probability of occurring. For example, for a given camera viewshed, jay walking may occur more frequently than armed robberies. Even though this may be the case, the user of this system may not have an interest in detecting jay walking. Therefore, the heat map generated at step 403 may comprise a heat map of only certain types of incidents (e.g., armed robberies, muggings, assaults, . . . etc) and may exclude less severe incidents (e.g., jay walking, littering, . . . , etc.)

In one embodiment, pre-manufactured software such as the Omega Group's CrimeView® is utilized by processor 102 to generate the heat map. The heat map may utilize incident data stored in storage 112 in the generation of the heat map. In an alternate embodiment of the present invention, the heat map may be created by a separate entity (not shown) and provided to the VAE scheduler. Regardless of how the heat map is generated and/or obtained, the heat map is stored in storage 108.

At step 405, a topographical map stored in storage 110 may be utilized along with the camera's geographic location or set of possible geographic locations (which may also be stored in storage 110) to determine a camera viewshed for a particular camera. As discussed previously, the camera's viewshed comprises fields of view visible from the particular camera's geographic location or set of possible geographic locations (in the case of a moveable camera). The map may be used to determine obstructions such as buildings, bridges, hills, etc. that may obstruct the camera's view. In one embodiment, a location for a particular camera is determined and unobstructed views for the camera are determined based on the geographic location or set of possible geographic locations of the camera unobstructed views for the camera. The camera viewshed is then determined based on the unobstructed views for the camera at the location.

In another embodiment, the camera's viewshed is determined by identifying the geographic location or set of possible geographic locations that the camera can occupy and simply determining that the camera can view a certain fixed distance around the geographic location or set of geographic locations based on the optics in the camera's lens. In yet another embodiment, the camera's viewshed is determined manually by having a person move the camera through all its possible views and noting on a map exactly which areas the camera can view. Regardless of how the viewshed is generated and/or obtained, the viewshed is stored in storage 118.

At step 407, processor 102 uses the heat map and the camera viewshed to determine an incident type having a greater (highest) probability of occurring at a particular time within the camera's viewshed. It should be noted that the incident having a highest probability of occurrence may be determined from a plurality of incident types. For example a heat map may be generated showing occurrences of 15 incidents within a geographic area. The one type of incident among the plurality of incidents that has the highest probability of occurrence may then be utilized when determining what VAE to use for a particular camera.

The VAE schedule is then created/generated based on this determination. More particularly, the VAE schedule is created/generated based on the incident heat map and the camera viewshed such that a camera will use a particular VAE tailored to detect a particular type of incident at times the type of incident is most likely to occur (step 409). Thus, at step 409, the step of generating the schedule for the camera comprises the step of determining types of incidents within the camera viewshed that have a higher probability of occurrence, and generating the schedule so that the camera (or multiple cameras) will utilize a VAE that is tailored to detect the incident.

Finally, at step 411 the VAE schedule is communicated/transmitted to the particular camera 204 or camera controller 104 assigned to camera 204 using network interface 106. As discussed above, the schedule comprises a schedule for the camera to autonomously change its VAE.

It should be noted that while the logic flow of FIG. 4 describes the generation of a schedule for a single camera, the process flow of FIG. 4 may be repeatedly performed for multiple cameras such that each camera has a unique VAE schedule to detect the incidents with the desired attributes within the camera's viewshed.

FIG. 5 is a flow chart depicting the operation of the camera controller of FIG. 2. Although the camera controller may determine an appropriate VAE schedule for a camera as described above, in this particular embodiment, the camera controller simply obtains the VAE schedule from VAE scheduler 100. The logic flow begins at step 501 where network interface 206 receives a VAE schedule. At step 503, the VAE schedule is stored in storage 212. Finally, processor 202 executes VAE program 216 which reads the stored VAE schedule, and sends appropriate directives to the appropriate camera at an appropriate time to adjust the camera's VAE accordingly.

FIG. 6 is a flow chart depicting the operation of the camera of FIG. 3. The logic flow begins at step 601 where network interface 306 receives a directive to change the camera's current VAE. At step 603, processor 302 then modifies its present VAE. Finally, at step 605 logic circuitry 302 uses the current VAE along with detected video to identify a particular type of event (incident).

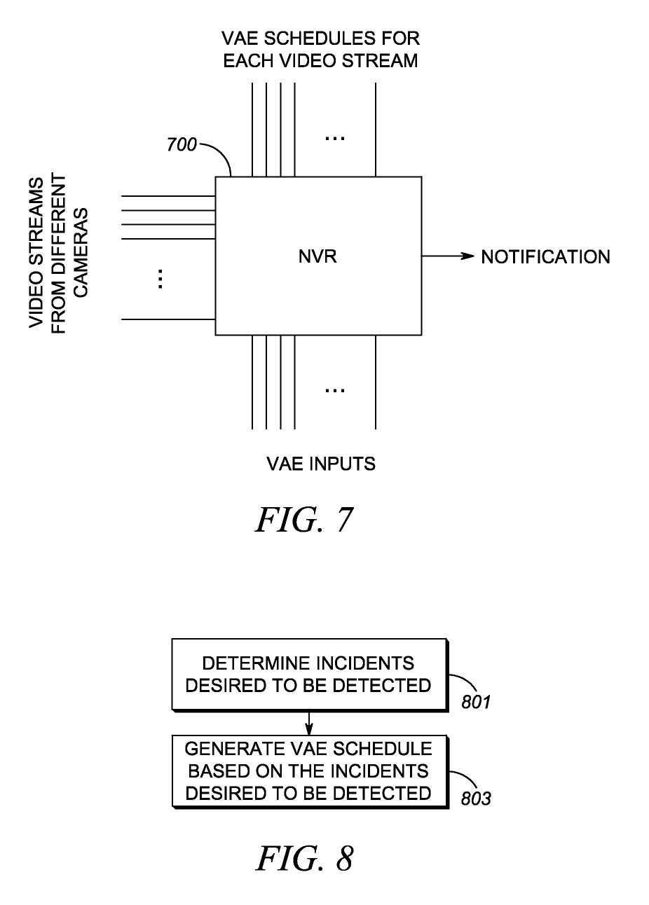

In the foregoing specification, specific embodiments have been described. However, one of ordinary skill in the art appreciates that various modifications and changes can be made without departing from the scope of the invention as set forth in the claims below. For example, the above description was oriented towards video analytics running on the camera, with the cameras changing their VAE according to a VAE schedule. In reality video analytics could (and often does) run in an infrastructure component or network equipment such as an NVR. Thus, any piece of network equipment performing video analytics will be provided (or determine itself) a VAE schedule to be executed as described above. This is illustrated in FIG. 7.

FIG. 7 shows multiple video streams from multiple cameras entering NVR 700. Each video stream has an associated VAE schedule so that a first VAE is run during a first time frame, and a second VAE is run during a second timeframe. Additionally the VAEs are input into NVR 700. During operation the multiple video streams are analyzed with a particular VAE according to a schedule for that video stream (each video stream has its own, unique schedule). When an event is detected, a notification can then be output by NVR 700. Although the network equipment illustrated in FIG. 8 comprises an NVR 700, it is envisioned that the invention claimed below may reside on any piece of network equipment. Accordingly, the specification and figures are to be regarded in an illustrative rather than a restrictive sense, and all such modifications are intended to be included within the scope of present teachings.

Additionally, the main focus of the above description was determining a VAE schedule based detecting events that occur most often. There could actually be a number of different criteria for determining what VAE to use. These criteria may include the proximity to sensitive infrastructure/schools/etc., type of incident, severity of incident, other agency policies, etc. FIG. 8 illustrates the generation of a VAE schedule in accordance with a further embodiment. The logic flow begins at step 801 where processor 102 determines a plurality of incidents desired to be detected. As discussed above, these incidents may comprise a small set of incidents of a more-severe nature (e.g., violent crimes). These may also comprise types of incidents that are judged relevant to a particular location and/or time. For example, an incident of interest may comprise loitering near a school during school hours. These incidents may be input by a user of device 100 through a graphical user interface (GUI) 125. GUI 205 may include a monitor, a keyboard, a mouse, a speaker, and/or various other hardware components to provide a man/machine interface.

Once processor 102 determines those incidents of interest, processor 102 then generates a VAE schedule for at least one video stream based on the incidents desired to be detected (step 803). As discussed above, the step of generating the VAE schedule for the video stream comprises the steps of determining or obtaining a type of incident most likely to occur. When this is the case, the step of generating the VAE comprises generating the VAE based on the type of incident most likely to occur.

Also, although not necessary for practicing the invention, processor 102 may determine or obtain a camera viewshed and generate the VAE based on the type of incident most likely to occur and the camera viewshed. As discussed above, the camera viewshed may be determined by determining or obtaining a geographic location or set of possible geographic locations for the camera and then using a map to determine unobstructed views for the camera based on the geographic location or set of possible geographic locations of the camera. The camera viewshed could then be based on the unobstructed views for the camera.

As discussed above, the VAE schedule causes network equipment (e.g., a camera or NVR) to use a first VAE at a first time and a second VAE at a second time. The network equipment autonomously change its VAE based on time.

If the above process does not take place in the camera, a network interface may be utilized to transmit the VAE schedule to the desired network equipment.

Those skilled in the art will further recognize that references to specific implementation embodiments such as “circuitry” may equally be accomplished via either on general purpose computing apparatus (e.g., CPU) or specialized processing apparatus (e.g., DSP) executing software instructions stored in non-transitory computer-readable memory. It will also be understood that the terms and expressions used herein have the ordinary technical meaning as is accorded to such terms and expressions by persons skilled in the technical field as set forth above except where different specific meanings have otherwise been set forth herein.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for determining a video analysis engine (VAE) schedule for a video stream associated with a camera, the method comprising the steps of:
determining a plurality of incidents desired to be detected;
generating a VAE schedule for the video stream based on the incidents desired to be detected.

2. The method of claim 1 wherein the step of generating the VAE schedule for the video stream comprises the step of:
determining or obtaining a type of incident most likely to occur;
wherein the step of generating the VAE comprises generating the VAE based on the type of incident most likely to occur.

3. The method of claim 2 further comprising the steps of:
determining or obtaining a camera viewshed for the camera; and
wherein the step of generating the VAE comprises generating the VAE based on the type of incident most likely to occur and the camera viewshed.

4. The method of claim 3 wherein the step of determining the camera viewshed comprises the steps of:
determining or obtaining a geographic location or set of possible geographic locations for the camera;
using a map to determine unobstructed views for the camera based on the geographic location or set of possible geographic locations of the camera; and
determining the camera viewshed based on the unobstructed views for the camera.

5. The method of claim 1 wherein the step of determining the plurality of incidents desired to be detected comprises the steps of determining incidents based on proximity to sensitive infrastructure/schools/etc., type of incident, or severity of incident.

6. The method of claim 1 wherein the VAE schedule causes network equipment to use a first VAE at a first time and a second VAE at a second time.

7. The method of claim 6 wherein the VAE schedule comprises a schedule for the network equipment to autonomously change its VAE based on time.

8. The method of claim 1 further comprising the step of:
transmitting the VAE schedule to network equipment.

9. A method for creating a video analysis engine (VAE) schedule for a video stream associated with a camera, the method comprising the steps of:
determining or obtaining a geographic location or set of possible geographic locations for the camera;
determining or obtaining a heat map for the geographic location or set of possible geographic locations using historical incident data for incidents desired to be detected;
determining or obtaining a viewshed for the camera based on the geographic location or set of possible geographic locations;
using the heat map and the viewshed to determine the types of incidents desired to be detected; and
using the determined incidents and the viewshed to create the VAE schedule.

10. The method of claim 9 further comprising the step of:
transmitting the VAE schedule to the camera or a camera controller or a Network Video Recorder or other network equipment.

11. The method of claim 9 further comprising the step of:
determining the incidents desired to be detected based on the types of incidents that have a greater probability of occurrence, proximity of incidents occurrence to sensitive infrastructure/schools/etc., type of incident, or severity of incident.

12. The method of claim 10 wherein the VAE schedule comprises a schedule for the network equipment to use a first VAE for a first period of time and a second VAE for a second period of time.

13. An apparatus comprising:
a processor determining a plurality of incidents desired to be detected and generating a VAE schedule for a video stream based on the incidents desired to be detected.

14. The apparatus of claim 13 wherein the processor determines the VAE schedule by determining or obtaining a type of incident most likely to occur; and
the processor generates the VAE schedule based on the type of incident most likely to occur.

15. The apparatus of claim 13 wherein the processor determines or obtains a camera viewshed and generates the VAE based on the type of incident most likely to occur and the camera viewshed.

16. The apparatus of claim 15 wherein the processor determines the camera viewshed by:
determining or obtaining a geographic location or set of possible geographic locations for the camera;
using a map to determine unobstructed views for the camera based on the geographic location or set of possible geographic locations of the camera; and
determining the camera viewshed based on the unobstructed views for the camera.

17. The apparatus of claim 13 wherein the VAE schedule causes network equipment to use a first VAE at a first time and a second VAE at a second time.

18. The apparatus of claim 17 wherein the VAE schedule comprises a schedule for the network equipment to autonomously change its VAE based on time.

19. The apparatus of claim 13 further comprising a network interface for transmitting the VAE schedule to network equipment.

20. The apparatus of claim 13 wherein processor determines the plurality of incidents desired to be detected is based on the type of incident most likely to occur, proximity of incidents occurrence to sensitive infrastructure/schools/etc., type of incident, or severity of incident.
